(19) United States
(12) Patent Application Publication
(10) Pub. No.: US 2018/0249055 A1
(43) Pub. Date: Aug. 30, 2018

(54) IMAGING APPARATUS

(71) Applicant: CANON KABUSHIKI KAISHA, Tokyo (JP)

(72) Inventor: Haruhiko Nakatsu, Moriya-shi (JP)

(21) Appl. No.: 15/754,494

(22) PCT Filed: Aug. 10, 2016
(86) PCT No.: PCT/JP2016/003704

§ 371 Date: Feb. 22, 2018

(30) Foreign Application Priority Data
Aug. 28, 2015 (JP) 2015-169628

(51) Int. Cl. H04N 5/225; H04N 5/33; H04N 5/372; G06F 3/01

(52) U.S. Cl. CPC H04N 5/2258; G06F 3/017; H04N 5/372; H04N 5/33

(57) ABSTRACT

An imaging apparatus includes a gesture sensor that detects a movement of a detection target object near an imaging surface, and a camera that captures an object body placed on the imaging surface, wherein an optical path length of a light beam Sa of the gesture sensor is made shorter than an optical path length of a light beam Ia of the camera (Ia>Sa).

### TECHNICAL FIELD

The present invention relates to an imaging apparatus including a first imaging unit for detecting a user movement and a second imaging unit for capturing an object body.

### BACKGROUND ART

A user interface system that recognizes a gesture of a user on a projector-projected video to allow the user to perform an intuitive operation is used. A system like this recognizes a user's gesture on a projected video using a touch panel or a video recognition technology.

US2014/0292647 discusses an interactive projector that projects a video from a projection unit onto an object to be projected such as a table, captures and analyzes a hand movement of a user for a projected image with a first camera, and projects an image corresponding to the hand movement from the projection unit onto a projection surface. To record character information placed on the projection surface, a second camera is used to capture the character information for recording it as an image.

A depth of field is used as an index for determining whether a camera can read an object body correctly. The greater the depth of field is, the wider is the range for bringing the object body into focus. One way to increase the depth of field of a camera is to extend an optical path length of the camera. When an image to be captured by a camera is a document script, a greater depth of field is required so that characters included in a whole area of the captured image can be correctly read. This requirement is further increased when optical character reader (OCR) processing is performed for a captured image.

### CITATION LIST

### Patent Literature

US2014/0292647

### SUMMARY OF INVENTION

### Solution to Problem

According to an aspect of the present invention, an imaging apparatus includes a first imaging unit configured to include a first imaging element, and to detect a movement of a detection target object near an imaging surface, and a second imaging unit configured to include a second imaging element, and to capture an object body placed on the imaging surface, wherein a relation, “an optical path length from the second imaging element to the imaging surface>an optical path length from the first imaging element to the imaging surface” is satisfied.

Further features of the present invention will become apparent from the following description of exemplary embodiments with reference to the attached drawings.

### BRIEF DESCRIPTION OF DRAWINGS

FIG. 1 is a schematic diagram illustrating a usage state of an information processing apparatus in a first exemplary embodiment.

FIG. 2A is a diagram illustrating a configuration of the information processing apparatus in the first exemplary embodiment.

FIG. 2B is a diagram illustrating a configuration of the information processing apparatus in the first exemplary embodiment.

FIG. 3 is a block diagram of a projector in the first exemplary embodiment.

FIG. 4 is a perspective view of the information processing apparatus in the first exemplary embodiment.

FIG. 5 is a schematic cross section diagram of a camera and a gesture sensor in the first exemplary embodiment.

FIG. 6 is a schematic cross section diagram of the projector in the first exemplary embodiment.

FIG. 7 is a schematic diagram of the information processing apparatus in the first exemplary embodiment as viewed from above.

FIG. 8 is a perspective view of an information processing apparatus in a second exemplary embodiment.

FIG. 9 is a schematic cross section diagram of a camera and a gesture sensor in the second exemplary embodiment.

### DESCRIPTION OF EMBODIMENTS

### First Exemplary Embodiment

A first exemplary embodiment of the present invention is described in detail below with reference to the attached drawings. The components described in the exemplary embodiment below are only exemplary, and the scope of the present invention is not limited to those components.

<Usage State of Information Processing Apparatus 109>

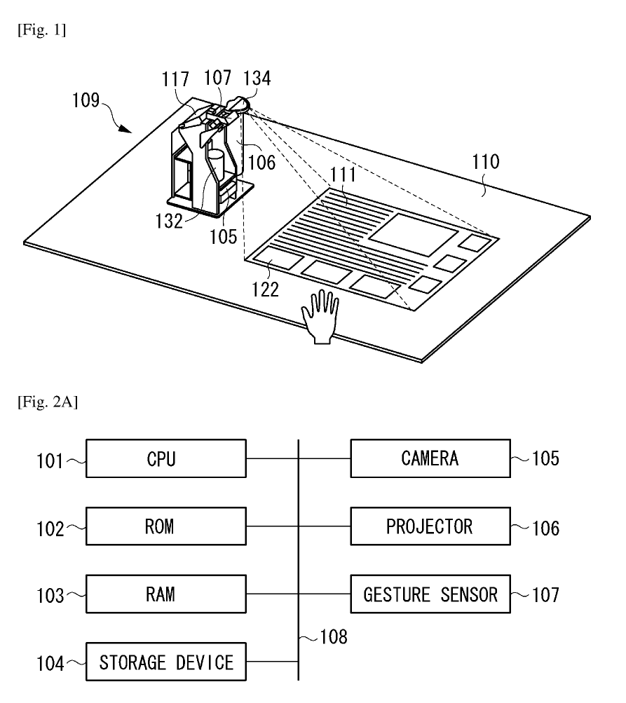

FIG. 1 is a schematic diagram illustrating a usage state of an information processing apparatus 109 which is an imaging apparatus in the exemplary embodiment.

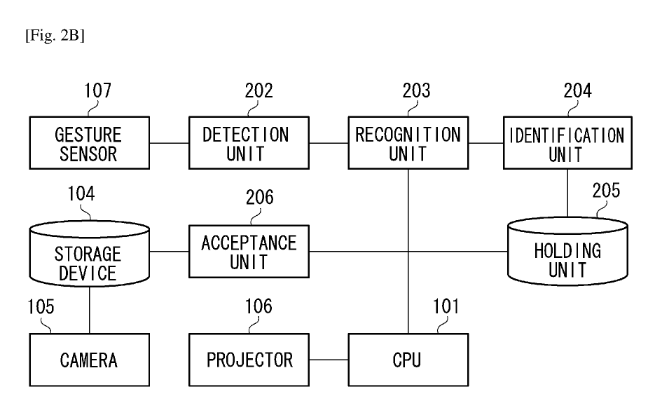

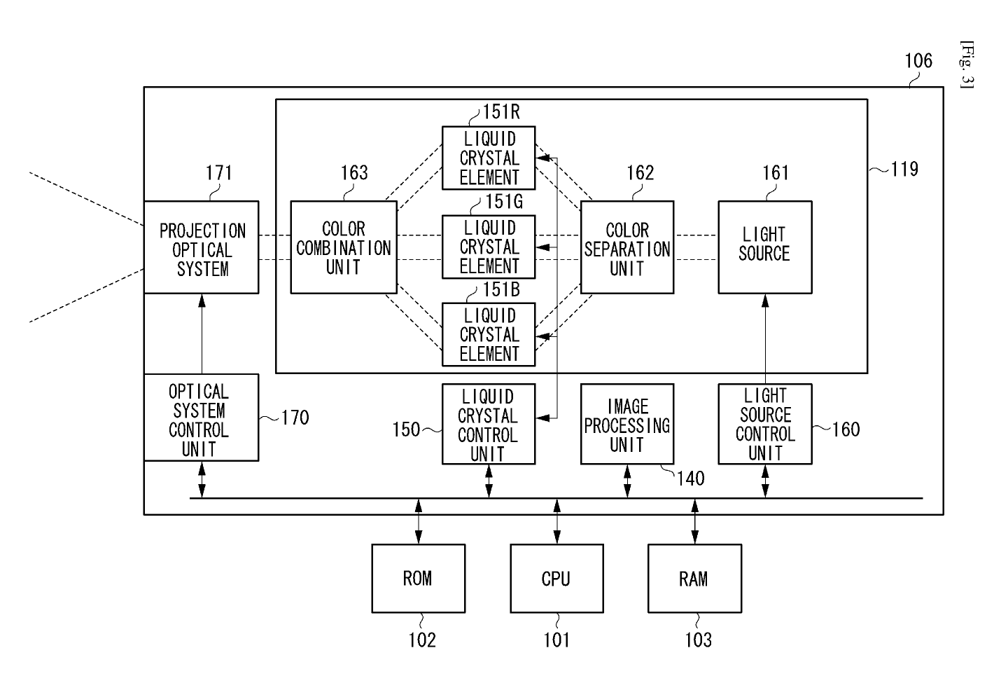

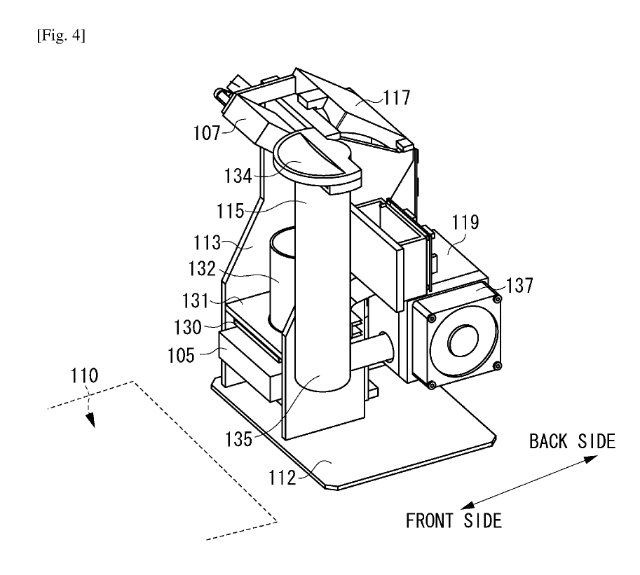

The information processing apparatus 109 includes a projector 106 serving as a projection unit, a gesture sensor 107 serving as a first imaging unit, a camera 105 serving as a second imaging unit, and a lens barrel 132 (See FIG. 2A and FIG. 4.).

The projector 106 projects an image 111 onto a projection surface 110 (Because an imaging surface 301 to be described below is equivalent to the projection surface 110, only the projection surface 110 is described).

A user performs an operation for this image 111. The projected image 111 includes a menu button 122 via which the user uses a finger to select a power ON/OFF operation or other operations. A user's operation selection, which is detected by the gesture sensor 107, functions as an interface.

When the user wants to capture a document using the information processing apparatus 109, an object body (a document) to be captured is placed on the projection surface 110 to allow the camera 105 to capture the document as an image.

In the apparatus itself, a side on which an image is projected is a front side and its opposite side is a back side. The respective sides of the apparatus viewed from the front side are a right side and a left side.

<Description of Information Processing Apparatus 109>

FIG. 2A is a diagram illustrating a hardware configuration of the information processing apparatus 109 in the present exemplary embodiment. In FIG. 2A, a central processing unit (CPU) 101, which is composed of a microcomputer, performs calculation and logic determination for various types of processing, and controls respective components connected to a system bus 108. A read only memory (ROM) 102 is a program memory in which programs for use by the CPU 101 for controlling operations are stored. A random access memory (RAM) 103 is a data memory having a work area used by the programs to be executed by the CPU 101, a data saving area in which data is saved when an error occurs, and a program loading area in which the control programs are loaded. A storage device 104, which is composed of a hard disk drive or an externally connected storage device, stores various types of data, such as electronic data used in the present exemplary embodiment, and programs. The camera 105, a second imaging unit, captures a work space where the user performs an operation, and supplies the captured image to a system as an input image. The projector 106, serving as a projection unit, projects a video, which includes electronic data and user interface components, onto the work space. The gesture sensor 107, serving as a first imaging unit, is a red-green-blue (RGB) or monochrome charge coupled device (CCD) camera. The gesture sensor 107 detects a movement of a detection target object such as a user's hand in the work space and, based on such detection, detects whether the user has touched an operation button and so on projected on the projection surface 110 (see FIG. 1). In the present exemplary embodiment, the projection surface 110 is a flat surface below the information processing apparatus such as a surface of a table on which the information processing apparatus 109 is placed. Another configuration is also possible. For example, the projection surface 110 may be provided as a part of the information processing apparatus 109 so that an image from the projector 106 can be projected thereon.

FIG. 2B is diagram illustrating a functional configuration of the information processing apparatus 109 in the present exemplary embodiment. In FIG. 2B, the camera 105 captures an object body, such as a document hand-written by the user, placed on the projection surface 110, and determines characters and such in that document. The projector 106 projects a screen, such as a user interface, onto the projection surface 110 (see FIG. 1). The projector 106 can also project an image captured by the camera 105. The gesture sensor 107 detects, in the work space on the projection surface 110 (see FIG. 1), an operation by a hand of the user on the user interface projected onto the projection surface 110 by the projector 106. When the user interface is operated by the hand of the user, an image projected by the projector 106 is changed or an image is captured by the camera 105. A detection unit 202, which is composed of the CPU, ROM, and RAM (hereinafter called the CPU 101 and so on), detects an area where a user's hand is present and an area where a user's finger is present based on the detection signal by the gesture sensor 107. In the description below, the detection of these areas is called the detection of a user's hand/finger (a detection target object).

A recognition unit 203, which is composed of a CPU and other components, tracks a user's hand/finger detected by the gesture sensor 107 and the detection unit 202 to recognize a gesture operation performed by the user. An identification unit 204, which is composed of a CPU and other components, identifies which user's finger was used to perform the gesture operation recognized by the recognition unit 203. A holding unit 205, which is composed of a CPU and other components, holds, in a storage area provided in the RAM 103, object information included in the projected electronic data and specified by a user via a gesture operation in association with the finger used for the gesture operation. An acceptance unit 206, which is composed of a CPU and other components, accepts an editing operation specified for electronic data via the gesture operation recognized by the recognition unit 203, and, as necessary, updates electronic data stored in the storage device 104. The storage device 104 stores electronic data that is to be processed via an editing operation. The CPU 101 refers to the information held in the holding unit 205 according to the gesture recognized by the recognition unit 203, and generates a projection image to be projected on the work space. The projector 106 projects a projection video generated by the CPU 101 onto the work space that includes the projection surface 110 and the user's hand near the projection surface 110.

<Block Diagram of Projector 106>

FIG. 3 illustrates a block diagram of the projector 106.

The projector 106 includes a liquid crystal control unit 150, liquid crystal elements 151R, 151G, and 151B, a light source control unit 160, a light source 161, a color separation unit 162, a color combination unit 163, an optical system control unit 170, and a projection optical system 171.

The liquid crystal control unit 150 controls a voltage applied to liquid crystals of pixels of the liquid crystal elements 151R, 151G, and 151B based on an image signal, which has been processed by an image processing unit 140, to adjust transmittance of the liquid crystal elements 151R, 151G, and 151B.

The liquid crystal control unit 150 includes a microprocessor for a control operation.

Each time one frame image is received from the image processing unit 140 when an image signal is input to the image processing unit 140, the liquid crystal control unit 150 controls the liquid crystal elements 151R, 151G, and 151B so that the transmittance corresponds to the image.

The liquid crystal element 151R, a liquid crystal element corresponding to red, adjusts the transmittance of red light that is included in the light output from the light source 161 and is one of the colors separated by the color separation unit 162 into red (R), green (G), and blue (B).

The liquid crystal element 151G, a liquid crystal element corresponding to green, adjusts the transmittance of green light that is included in the light output from the light source 161 and is one of the colors separated by the color separation unit 162 into red (R), green (G), and blue (B).

The liquid crystal element 151B, a liquid crystal element corresponding to blue, adjusts the transmittance of blue light that is included in the light output from the light source 161 and is one of the colors separated by the color separation unit 162 into red (R), green (G), and blue (B).

The light source control unit 160, which controls a ON/OFF state of the light source 161 and controls the amount of light, includes a microprocessor for a control operation.

The light source 161 is to output light for projecting an image onto the projection surface. For example, a halogen lamp is used as the light source 161.

The color separation unit 162 is to separate the light, which is output from the light source 161, into red (R), green (G), and blue (B). For example, a dichroic mirror is used as the color separation unit 162.

When a light emitting device (LED) corresponding to each of colors is used as the light source 161, the color separation unit 162 is not necessary.

The color combination unit 163 is to combine light components of red (R), green (G), and blue (B) respectively transmitted through the liquid crystal elements 151R, 151G, and 151B. For example, a dichroic mirror is used as the color combination unit 163.

The light generated by combining the components of red (R), green (G), and blue (B) by the color combination unit 163 is sent to the projection optical system 171.

The liquid crystal elements 151R, 151G, and 151B are controlled by the liquid crystal control unit 150 so that the each transmittance becomes the transmittance of light corresponding to an image input from the image processing unit 140.

When the light combined by the color combination unit 163 is projected onto the screen by the projection optical system 171, an image corresponding to the image input by the image processing unit 140 is displayed on the projection surface.

The optical system control unit 170, which controls the projection optical system 171, includes a microprocessor for a control operation.

The projection optical system 171 is to project the combined light, which is output from the color combination unit 163, onto the projection surface. The projection optical system 171 includes a plurality of lenses.

A light source unit 119 includes the light source 161, the color separation unit 162, the liquid crystal elements 151R, 151G, and 151B, and the color combination unit 163.

<Configuration of Projector 106>

FIG. 4 is a perspective view of the whole information processing apparatus 109. The configuration of the projector 106 is described with reference to FIG. 4.

The projector 106 includes the light source unit 119 and a lens barrel unit 115 in which the projection optical system 171 is stored.

The light source unit 119 and the lens barrel unit 115 are connected via a bending portion 135. The light source unit 119 is arranged in the back side of the bending portion 135. A reflection mirror 136 (see FIG. 6) is arranged at the position of the bending portion 135.

Another reflection mirror 134 is arranged on the upper front side of the lens barrel unit 115. The reflection mirror 134 reflects light toward the projection surface 110 to project an image on the projection surface 110. The reflection mirror 136 arranged in the bending portion 135 reflects light output from the light source unit 119 toward the reflection mirror 134.

A cooling mechanism 137 is provided next to the light source unit 119 to radiate heat generated by the light source unit 119.

FIG. 6 is a schematic cross section diagram of the projector. FIG. 6 illustrates the liquid crystal element 151R only, and the liquid crystal elements 151G and 151B are omitted here. The projection surface 110 and the liquid crystal elements 151R, 151G, and 151B are conjugated to each other, and light from each liquid crystal element passes through the color combination unit 163 and the projection optical system 171 and, after being reflected by the reflection mirror 134, reaches the projection surface 110. Let Ja be a light beam that is directed toward the center of the projection surface 110 when an image is projected onto the projection surface 110. An optical path length of the projector 106 is defined by an optical path length of the light beam Ja. The optical path length of the light beam Ja is the sum of a distance between the point Ra1 that is an intersection with the projection surface 110 and the point Ra2 that is an intersection with the reflection surface of the reflection mirror 134, a distance between the point Ra2 that is the intersection with the reflection surface of the reflection mirror 134 and the point Ra3 that is an intersection with the reelection surface of the reflection mirror 136 provided in the bending portion 135, and a distance between the point Ra3 that is the intersection with the reflection surface of the reflection mirror 136 and the liquid crystal element 151R.

### <Configuration of Camera 105 and Lens Barrel 132>

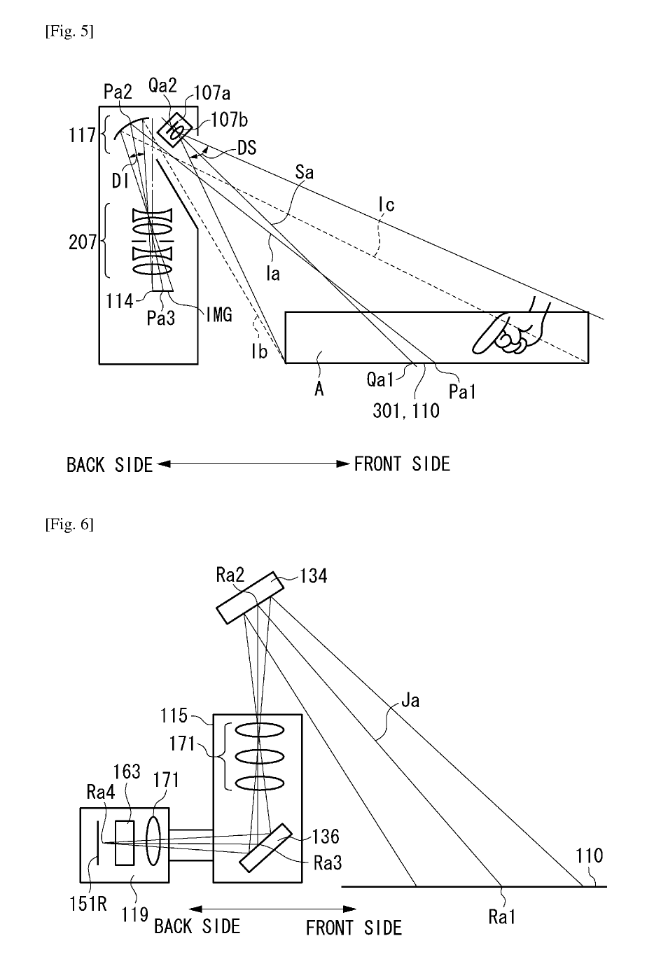

The configuration of the camera 105 and other components is described below with reference to FIGS. 4 and 5.

The camera 105 includes a CCD sensor 114 (see FIG. 5) serving as a second imaging element. A main frame 113 is fixed on a pedestal 112. A camera attachment 130 is attached to the main frame 113. The camera 105 is mounted to a camera mount 131 via the camera attachment 130. The lens barrel 132, in which a plurality of lenses 207 (see FIG. 5) serving as a second imaging optical system is included, is mounted on the camera mount 131. An imaging mirror 117, which is a concave curved mirror, is assembled on the main frame 113. The imaging mirror 117 is arranged in the back side of an optical axis of the lenses 207.

When an object body placed on the projection surface 110 is read by the camera 105, an image of the object body is reflected by the imaging mirror 117 into the lens barrel 132, and the reflected image, which passes through the lenses 207 inside the lens barrel 132, is read by the CCD sensor 114 (see FIG. 5).

FIG. 5 is a schematic cross section diagram of the camera 105 and the gesture sensor 107. The camera 105 and its optical path length are described with reference to FIG. 5.

The CCD sensor 114 is installed approximately horizontally to the projection surface 110. The lenses 207 are installed with its optical axis approximately perpendicular to the projection surface 110.

An object image of the object body placed on the imaging surface 301, which is the same surface as the projection surface 110, passes through the imaging mirror 117 and the plurality of lenses 207 and, after that, an image is formed on the light receiving surface of the CCD sensor 114.

An image plane IMG formed on the light receiving surface of the CCD sensor 114 is a shift optical system in which the image plane IMG shifts toward a right side in the figure with respect to the optical axis of the plurality of lenses 207.

Let Ia be a light beam directed toward the center of the imaging surface 301 when the imaging surface 301 is captured. Let Ib and Ic be light beams directed toward both left and right end-sides of the imaging surface 301, respectively, when the imaging surface 301 is captured.

The optical path length of the camera 105 is defined by an optical path length of the light beam Ia.

The optical path length of the light beam Ia is the sum of a distance between the point Pa1 that is an intersection with the imaging surface 301 and the point Pa2 that is an intersection with the reflection surface of the imaging mirror 117 and a distance between the point Pa2 that is the intersection with the reflection surface of the imaging mirror 117 and the point Pa3 where an image is formed on the IMG.

### <Configuration of Gesture Sensor 107>

The configuration of the gesture sensor 107 is described with reference to FIG. 4 and FIG. 5.

The gesture sensor 107 is attached to the main frame 113. The gesture sensor 107 includes a CCD sensor 107a serving as a first imaging unit and at least one lens 107b (a first imaging optical system) made of resin. The gesture sensor 107 is attached to the leading edge of the imaging mirror 117.

In order for the gesture sensor 107 to detect a movement of a user's hand/finger extended above the projection surface 110, it is necessary to reserve a detection area such that an area A having a height of 100 mm above the projection surface 110 can be detected. The gesture sensor 107 recognizes a movement of a user's hand/finger with a viewing angle of 60 degrees in front and back directions, and 90 degrees in right and left directions, with respect to the optical axis. The gesture sensor 107 is arranged in an area where it does not interfere with the light beams of the camera 105 and of the projector 106.

Let Sa be a light beam that passes through the optical axis of the lens 107b in the gesture sensor 107.

The optical path length of the gesture sensor 107 is defined by an optical path length of the light beam Sa. The optical path length of the light beam Sa is a distance between the point Qa1 that is an intersection with the imaging surface 301 and the point Qa2 where an image is formed on the CCD sensor 107a.

### <Relation Between Optical Path Length of Camera 105 and Optical Path Length of Gesture Sensor 107>

The optical path lengths of the components such as the camera 105 are described below with reference to FIG. 5 and FIG. 6.

The relation among the optical path length of the light beam Ia of the camera 105, the optical path length of the light beam Sa of the gesture sensor 107, and the optical path length of the light Ja of the projector 106 is as follows; the optical path length of the camera 105>the optical path length of the projector 106>the optical path length of the gesture sensor 107.

The reason for the relation, “the optical path length of the camera 105>the optical path length of the gesture sensor 107” is as follows. The camera 105 sometimes reads a document image to be processed via an optical character reader (OCR). For this reason, a readable range (range for bringing an object into focus) of a reading image is increased by extending the optical path length of the light beam Ia using the imaging mirror 117 to increase a depth of field. On the other hand, the gesture sensor 107 is required only to detect a user's hand/finger and not required to have a reading ability with accuracy as high as that of the camera 105. Accordingly, the optical path length of the light beam Sa of the gesture sensor 107 is made shorter than the optical path length of the light beam Ia of the camera 105 (Ia>Sa).

To make the optical path length of the light beam Sa of the gesture sensor 107 the same length as the optical path length of the light beam Ia of the camera 105, a mirror to reflect the light beam Sa of the gesture sensor 107 should be added. Adding such a mirror makes the information processing apparatus 109 larger. Therefore, the relation, Ia>Sa, if satisfied, makes the apparatus more compact. The mirror mentioned here for reflecting the light beam Sa of the gesture sensor 107 refers not to an optical system included in the gesture sensor 107, but to a mirror provided externally to the gesture sensor 107.

The relation among the optical path length of the projector 106, the optical path length of the camera 105, and the optical path length of the gesture sensor 107 is described below. There is no need for the projector 106 to have a long optical path length as that of the camera 105, because the projector 106 is not required to have reading performance equivalent to that of the camera 105. On the other hand, it is preferable for the projector 106 to have an optical path length longer than that of the gesture sensor 107, because the projector 106 is required to project the image 111 onto the projection surface 110. Thus, the optical path length relation, “the optical path length of the camera 105>the optical path length of the projector 106>the optical path length of the gesture sensor 107” is required.

<Relation of Viewing Angles>

The relation between a viewing angle of the camera 105 and a viewing angle of the gesture sensor 107 is described below with reference to FIG. 5.

In FIG. 5, let DI be a viewing angle of the lenses 207 of the camera 105, and let DS be a viewing angle of the lens 107b of the gesture sensor 107.

The viewing angle DS of the lens 107b of the gesture sensor 107 is set wider than the viewing angle DI of the lenses 207 of the camera 105. Setting the viewing angles in this manner allows a readable area of the gesture sensor 107 to be set approximately in the same range as that of a readable area of the camera 105 while satisfying the relation, “the optical path length of Ia>the optical path length of Sa”.

<Arrangement Configuration of Imaging mirror 117 and Gesture sensor 107>

FIG. 7 illustrates a schematic diagram of the information processing apparatus 109 viewed from above (viewed from the direction perpendicular to the projection surface 110). The imaging mirror 117 is arranged in the back side of the optical axis of the lenses 207. The light source unit 119 and the reflection mirror 134 are arranged so that the imaging mirror 117 and the lenses 207 are respectively arranged in the right-to-left direction. In addition, as illustrated in FIG. 5, the imaging mirror 117 and the gesture sensor 107 are arranged so that at least a part of the imaging mirror 117 and at least a part of the gesture sensor 107 overlap in the height direction. In other words, when viewed in a back-to-front direction (horizontal direction) in FIG. 5, the imaging mirror 117 and the gesture sensor 107 are arranged so that at least a part of the imaging mirror 117 and at least a part of the gesture sensor 107 overlap. This arrangement makes the apparatus more compact in a front-to-back direction and in a right-to-left direction and, at the same time, in a height direction.

### Second Exemplary Embodiment

A second exemplary embodiment of the present invention is described in detail below with reference to the attached drawings. Only a part different from the first exemplary embodiment is described, and the description of a part similar to that in the first exemplary embodiment is omitted.

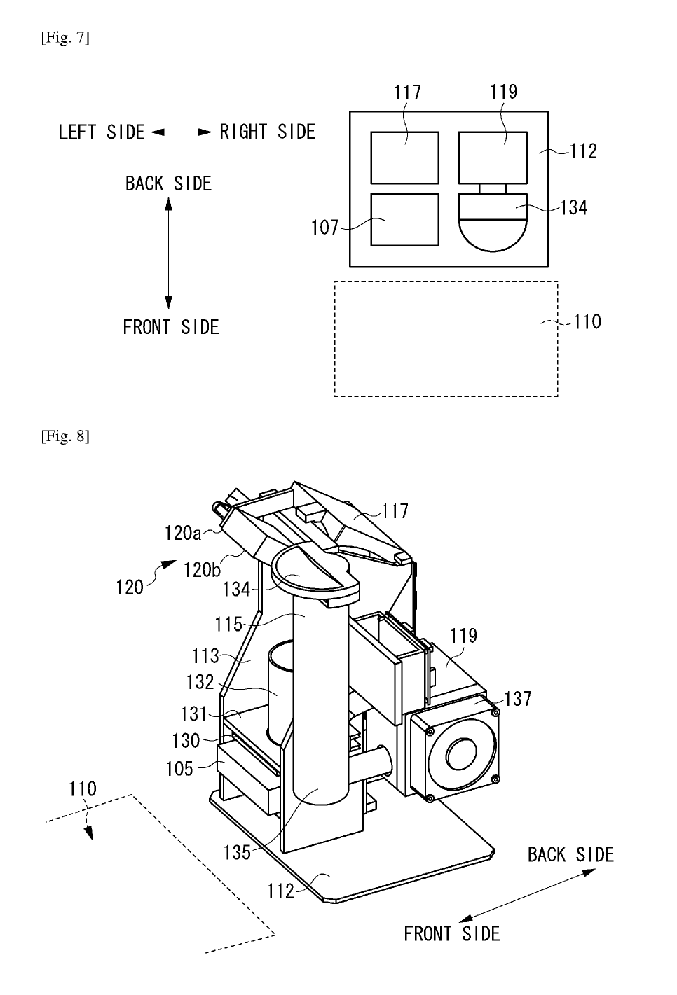

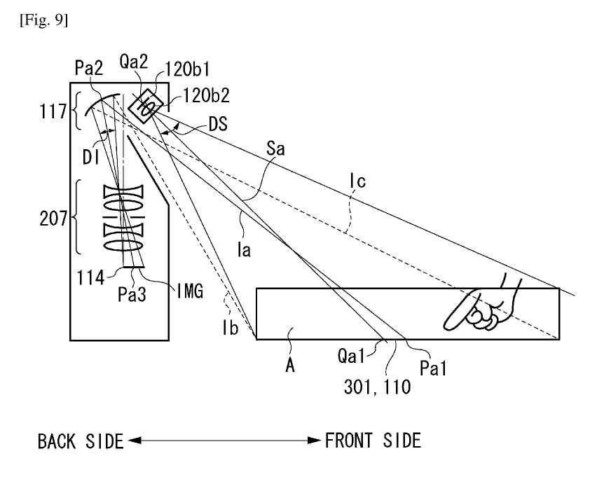

FIG. 8 is a perspective view of a whole information processing apparatus 109 in the second exemplary embodiment. The first exemplary embodiment and the second exemplary embodiment are different in a gesture sensor 120. In the first exemplary embodiment, a CCD camera is used as the gesture sensor serving as the first imaging unit. On the other hand, in the second exemplary embodiment, an infrared camera is used as the gesture sensor 120. The gesture sensor 120 includes a light emitting unit 120a that emits infrared light and a light receiving unit 120b that receives infrared light reflected by an object. The light emitting unit 120a emits infrared light toward a predetermined area on the projection surface 110 so that a user's hand/finger near the projection surface 110 can be recognized. The light receiving unit 120b includes a light receiving element 120b1, which is an imaging element, and a lens 120b2 (see FIG. 9). The light receiving element 120b1 receives light emitted by the light emitting unit 120a and reflected by the projection surface 110 or the user's hand/finger. The light receiving element 120b1 uses an area sensor that can receive light reflected by a predetermined area.

FIG. 9 is a schematic cross section diagram of the camera and the gesture sensor in the second exemplary embodiment. The basic configurations of the camera 105 and the gesture sensor 120 are similar to those in the first exemplary embodiment.

<Relation Between Optical Path Length of Camera 105 and Optical Path Length of Gesture Sensor 120>

The optical path lengths of the components, such as the camera 105, are described below with reference to FIG. 9. The optical path length of the camera 105 and the optical path length of the projector 106 are the same as those in the first exemplary embodiment, and, therefore, the description is omitted. Let Sa be a light beam that passes through the optical axis of the lens 120b2 in the gesture sensor 120.

The optical path length of the gesture sensor 120 is defined by the optical path length of the light Sa. The optical path length of the light Sa is a distance between the point Qa1 that is an intersection with the imaging surface 301 and the point Qa2 where an image is formed on the light receiving element 120b1.

At this time, the relation among the optical path lengths of the components, such as the camera 105, is as follows. the optical path length of the camera 105>the optical path length of the projector 106>the optical path length of the gesture sensor 120.

The reason for the relation, “the optical path length of the camera 105>the optical path length of the gesture sensor 120” is as follows. The camera 105 sometimes reads a document image to be processed via an OCR. For this reason, a readable range (range for bringing an object into focus) of a reading image is increased by extending the optical path length of the light beam Ia using the imaging mirror 117 to increase a depth of field. On the other hand, the gesture sensor 120 is required only to detect a user's hand/finger and not required to have a reading ability with accuracy as high as that of the camera 105. In addition, when an infrared camera is used for the gesture sensor 120, light attenuation in the infrared light used for the gesture sensor 120 increases as the optical path length between the light receiving element 120b1 and the projection surface 110 becomes longer. Therefore, it is desirable that the optical path length between the light receiving element 120b1 and the projection surface 110 be short. For this reason, the optical path length of the light beam Sa of the gesture sensor 120 is made shorter than the optical path length of the light beam Ia of the camera 105 (Ia>Sa).

The relation among the optical path length of the projector 106, the optical path length of the camera 105, and the optical path length of the gesture sensor 120 is the same as that in the first exemplary embodiment.

When an infrared camera is used for the gesture sensor 120 as in the second exemplary embodiment, the apparatus can also be made compact while maintaining the imaging performance of the camera 105 of the information processing apparatus 109 as in the first exemplary embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-169628, filed Aug. 28, 2015, which is hereby incorporated by reference herein in its entirety.

1. An imaging apparatus comprising:
a first imaging unit configured to include a first imaging element, and to detect a movement of a detection target object near an imaging surface; and
a second imaging unit configured to include a second imaging element, and to capture an object body placed on the imaging surface,
wherein a relation, “an optical path length from the second imaging element to the imaging surface>an optical path length from the first imaging element to the imaging surface” is satisfied.

2. The imaging apparatus according to claim 1, further comprising an imaging mirror arranged in an optical path from the object body placed on the imaging surface to the second imaging unit to capture the object body by the second imaging unit.

3. The imaging apparatus according to claim 1, wherein a mirror is not arranged between the imaging surface and the first imaging unit.

4. The imaging apparatus according to claim 3, wherein the first imaging unit is provided at the imaging mirror.

5. The imaging apparatus according to claim 1,
wherein the first imaging unit includes a first imaging optical system and the second imaging unit includes a second imaging optical system, and
wherein a viewing angle of the first imaging optical system is wider than a viewing angle of the second imaging optical system.

6. The imaging apparatus according to claim 1, wherein the first imaging unit and the imaging mirror are arranged in an overlapped manner when viewed in a horizontal direction.

7. The imaging apparatus according to claim 1, further comprising a projection unit configured to project an image onto the imaging surface,
wherein a relation, “an optical path length from the second imaging element to the imaging surface>an optical path length from the projection unit to the imaging surface>an optical path length from the first imaging element to the imaging surface” is satisfied.

8. The imaging apparatus according to claim 1, wherein the second imaging unit performs capturing based on detection by the first imaging unit.

9. The imaging apparatus according to claim 1, wherein the first imaging unit is a gesture sensor and the second imaging unit is a camera.

10. The imaging apparatus according to claim 1,
wherein the gesture sensor is an infrared camera, and
wherein the infrared camera comprises a light emitting unit configured to emit infrared light and a light receiving unit configured to receive the infrared light.

11. The imaging apparatus according to claim 1, wherein the gesture sensor is a CCD camera.
